(19) United States
(12) Patent Application Publication
(10) Pub. No.: US 2010/0085638 A1
(43) Pub. Date: Apr. 8, 2010

(54) Equatorial Support for Telescope

(75) Inventor: Claudio Lopresti, La Spezia (IT)

Correspondence Address: SHOEMAKER AND MATTARE, LTD, 10 POST OFFICE ROAD - SUITE 100, SILVER SPRING, MD, 20910, US

(73) Assignee: Franco Bercella, Ramiola di Medesano, Parma (IT)

(21) Appl. No.: 12/299,374

(22) PCT Filed: May 3, 2007
(86) PCT No.: PCT/IT2007/000330

§ 371 Date: Mar. 9, 2009

(30) Foreign Application Priority Data
May 3, 2006 (EP) 06425297.6

(51) Int. Cl. G02B 23/16

(52) U.S. Cl. 359/430

(57) ABSTRACT

The present invention relates to a mount for telescopes, particularly of a portable type for amateur or semi-amateur telescopes, though it can be also applied to fixed telescopes and professional telescopes.

Particularly, the present invention relates to a support for a telescope comprising a mount and means for resting said mount on the ground, wherein said mount comprises a primary rocking element allowing one to set the latitude of the observation place, to said primary rocking element being pivotally fastened a frame which allows moving the telescope about the right ascension axis and/or about the declination axis.

### FIELD OF THE INVENTION

The present invention relates to a support for telescopes, particularly of a portable type for amateur or semi-amateur telescopes, though it can be also applied to fixed telescopes and professional telescopes.

### BACKGROUND OF THE INVENTION

Various types of supports or mounts for telescopes are available. According to a first general classification, mounts can be divided into altazimuth mounts and equatorial mounts.

In altazimuth mounts, the two axes about which the telescope can move are the one orthogonal and the other parallel to the ground, such that the optics can move in all the directions along Cartesian axes. However, this arrangement of the axes of movement does not correspond to the arrangement of the Earth's axis and equatorial plane, which, as is known, at other latitudes than the poles are inclined relative thereto. Consequently, due to the Earth's true motion (spin about the North-South polar axis in the West-East direction), the optics, in order to track a celestial body in apparent motion, requires to be moved instant by instant along both axes in both directions. This movement is very complicated, and together with the rotation of the field of view during the movement, a prerequisite condition is also the constant movement of both motors relative to the two axes of movement (azimuth and altitude) in addition to a sophisticated automation (the so-called field derotator), which is normally inaccessible to beginners and amateur astronomers in general because of the high cost. The advantage of the altazimuth mount, however, is its weight balance, which makes it applicable also to large-sized telescopes.

The second type of mount, i.e. the equatorial mount, is characterized in that one of the two axes (said polar or right ascension axis) is capable of being inclined such as to be arranged parallel to the Earth's axis and thus perpendicular to the equator. Particularly, the right ascension axis (RA axis) is inclined by as many degrees as the ones of the latitude of the observation place and such as to be parallel to the pole (the North Pole for Northern hemisphere, and the South Pole for Southern hemisphere). This configuration allows one to track the apparent motion of a celestial body by moving the telescope about only one axis, i.e. by means of a simple motion that can be easily provided by means of an inexpensive drive. For this reason, the equatorial mount has become the most widely used in amateur telescopes.

Three main categories of equatorial mounts are available.

German mounts

fork mounts

English mounts (also said cradle or frame mounts).

German mounts consist of a cantilever framework supporting an optics that is capable of moving about a declination axis and about the polar axis (RA axis). The loads of the optical components are thus unbalanced to the North relative to the basement supporting the telescope. For this reason, the optical part has to be counter-balanced by suitably sized and spaced counterweights. A particular accessory, called the “equatorial head”, is indispensable for the polar axis to be properly oriented to the Celestial Pole.

Fork mounts also consist of a cantilever framework, with loads unbalanced to the North relative to the barycentre of the basement supporting the telescope. The optics is held by a U-shaped fork which rotates about the RA axis, the optics rotating therein about the declination axis. In this case, as no counter-weights are provided, in order to prevent that, due to the optical part unbalancing to the North, the instrument may fall in that direction, the equatorial head is built cantilevered to the South; thereby, the instrument barycentre is still inside the basement, but both the optics and equatorial head are, in this solution, cantilevered. Also in this case, the “equatorial head” is indispensable for the polar axis to be properly oriented to the Celestial Pole. The framework stiffening, to the purpose of restraining the inevitable vibrations of the cantilevered parts (the equatorial head and the fork), is only obtained by making the basement heavier, thus making the assembly more difficult to transport and also more expensive.

English mounts, on the other hand, consist of a frame placed on two piers, which holds the optics. The great advantage of this mount is that all weights are balanced, as their barycentre is at the intersection between the declination and right ascension axes. Due to this characteristic, the English mount is the elective mount for very large and heavy telescopes, particularly for the large telescopes in astronomical observatories, such as the Hale telescope at the Palomar Mountain observatory. English mount, however, has a drawback that makes it inapplicable to amateur telescopes: the two piers holding the frame along which the RA axis passes must be especially manufactured according to the latitude of the observatory location. In other words, the frame is pivotally fastened to the two piers at such points as dictated by the inclination that the RA axis must have, which, in turn, coincides with the latitude of the observation place. Furthermore, since it requires two support piers or frames, this mount is very bulky and heavy.

These characteristics make the English mount non-transportable, even if it were built in a size suitable for an amateur telescope. In fact, as small telescopes generally are not placed in a fixed location, they must be easy to transport in order to allow carrying out observation activities in places with low light and high air transparency, such as in the high mountains. Therefore, while on the one hand, a small size and a light weight are a selection factor for a telescope mount, on the other hand, whenever the latter has to be transported to a different place, the latitude requires to be adjusted, which cannot be done with English mounts.

In view of the above, it is understood that the commercially-available mounts for amateur telescopes are normally German or fork equatorial mounts and only seldom altazimuth ones, never English ones.

### OBJECT AND SUMMARY OF THE INVENTION

The problem at the heart of the present invention is thus to provide a support for telescopes which is characterized by being easily transported, free of cantilevered parts (and thus free of the vibrations generating therefrom) and by a perfect weight balance, such that relatively large-sized amateur telescopes are also made transportable.

This problem is solved by means of a telescope support comprising a mount and means for resting said mount on the ground, characterized in that said mount comprises a primary rocking element that allows setting the latitude of the observation place, a frame being pivotally fastened to said primary rocking element, which allows the telescope to be moved about the right ascension axis and/or about the declination axis, such as set forth in the annexed claims.

### BRIEF DESCRIPTION OF THE DRAWINGS

Further features and advantages of the present invention will be better understood from the description of some exemplary embodiments, which is given below by way of non-limiting illustration, with reference to the following figures:

FIG. 1 shows a perspective view of a telescope support according to the invention with a reflector telescope being fitted thereto;

FIG. 2 shows a perspective view of a second embodiment of the telescope support according to the invention;

FIG. 3 shows a perspective view of a different embodiment of the telescope mount for the support according to the invention;

FIGS. 4, 5 and 6 show a perspective view of different embodiments of the tripod according to the invention;

FIG. 7 shows a perspective view of a different embodiment of the support according to the invention;

FIG. 8 shows a perspective view of a further embodiment of the support according to the invention;

FIG. 9 shows a perspective view of a further embodiment of the support according to the invention being adapted to a fork mount;

FIG. 10 shows a perspective view of a further simplified embodiment of the support according to the invention;

FIG. 11 shows a perspective view of a further embodiment of the support according to the invention, in which the telescope consists of an open frame structure;

FIG. 12 shows a perspective view of a detail of the inventive support, according to a preferred embodiment;

FIG. 13 shows a perspective view of a different detail of the embodiment from FIG. 12;

FIG. 14 shows a partially sectional perspective view of a sliding element for the arc of circle-shaped elements of the inventive support;

FIG. 15 shows a sectional front view of the sliding mechanism of a different embodiment of the inventive sliding elements;

FIG. 16 shows a perspective view of a detail of the motor drive of the support according to the invention;

FIG. 17 shows a partially sectional side schematic view of a detail of the motor drive of the support of the invention;

FIG. 18 shows a side schematic view of a detail of a detail of the motor drive of the inventive support, according to a different embodiment;

FIG. 19 shows a partially cut-away perspective view of a detail of the inventive support, according to a different embodiment;

FIG. 20 shows a perspective view of a different embodiment of the support according to the invention;

FIG. 21 shows a perspective view of a different embodiment of the support according to the invention;

FIG. 22 shows a perspective view of a different embodiment of the support according to the invention;

FIGS. 23 to 26 show different views of a detail of the support according to the invention;

FIGS. 27 and 28 show two different embodiments of the detail in FIG. 23;

FIGS. 29, 30 and 31 are a schematic side view of three different configurations of the support according to the invention;

FIG. 32 shows a perspective view of a sliding element for a arc of circle-shaped element of the inventive support;

FIG. 33 shows a side view of a detail of a basement for a support according to the invention;

FIG. 34 shows a particular configuration of a telescope mounted to a support according to the invention;

FIG. 35 schematically shows one of the possible adjustments of the orientation of the telescope mounted to a support according to the invention.

### DETAILED DESCRIPTION OF THE PREFERRED EMBODIMENTS

With reference to the figures, the support of the invention for a telescope 2 is generally indicated with 1.

The telescope 2, which is schematically illustrated in form of a cylinder, can be of any type, though preferably will be a reflector telescope, such as a Newton, Dobson, Cassegrain, Schmidt-Cassegrain, catadioptric telescope, and variants thereof. This type of telescopes comprises a primary mirror, of which the diameter, focal length and optical configuration determine the luminosity and contrast of the image, and a more or less complicated optical system that conveys the image to an eyepiece, which will be responsible for the magnification thereof. As compared with refractor telescopes, reflection telescopes can be made with larger optics, while maintaining compactness and lightness. Furthermore, they are much less expensive than refractor ones, at the same optical aperture, and thus are the ones which are commonly selected by amateur users.

The support 1 comprises a mount 3 and means for resting 4 said mount 3 on the ground.

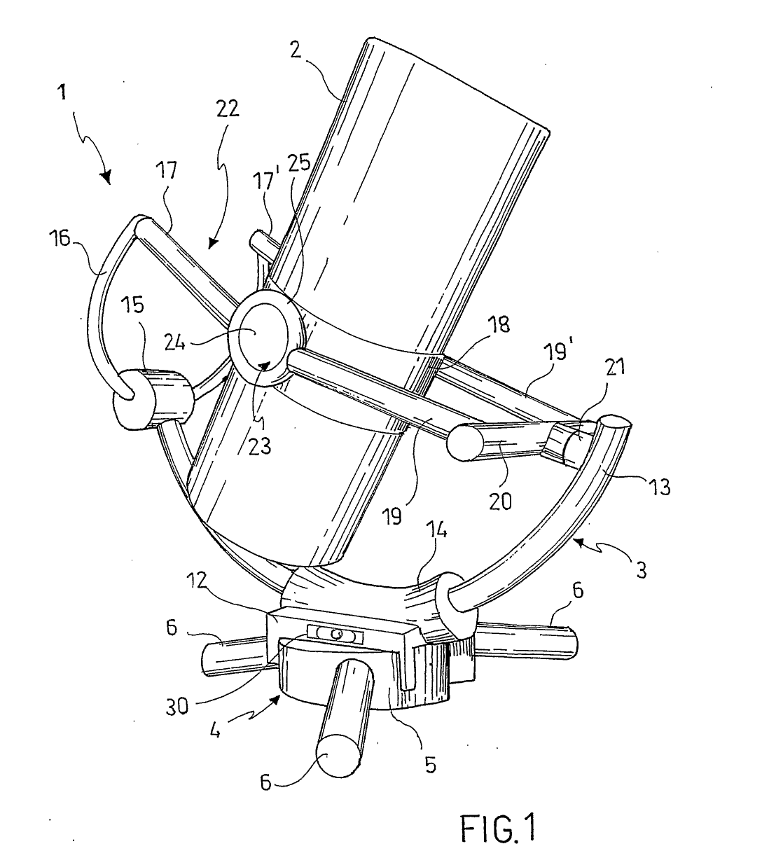

The rest means 4 shown in FIG. 1 are a low basement comprising a base element 5 to which three or more legs 6 are fastened such as to be radially projected therefrom. On the other hand, in the embodiment from FIG. 3, the rest means 4 are shaped as a traditional tripod, which provides to hold the mount 3 raised from the ground.

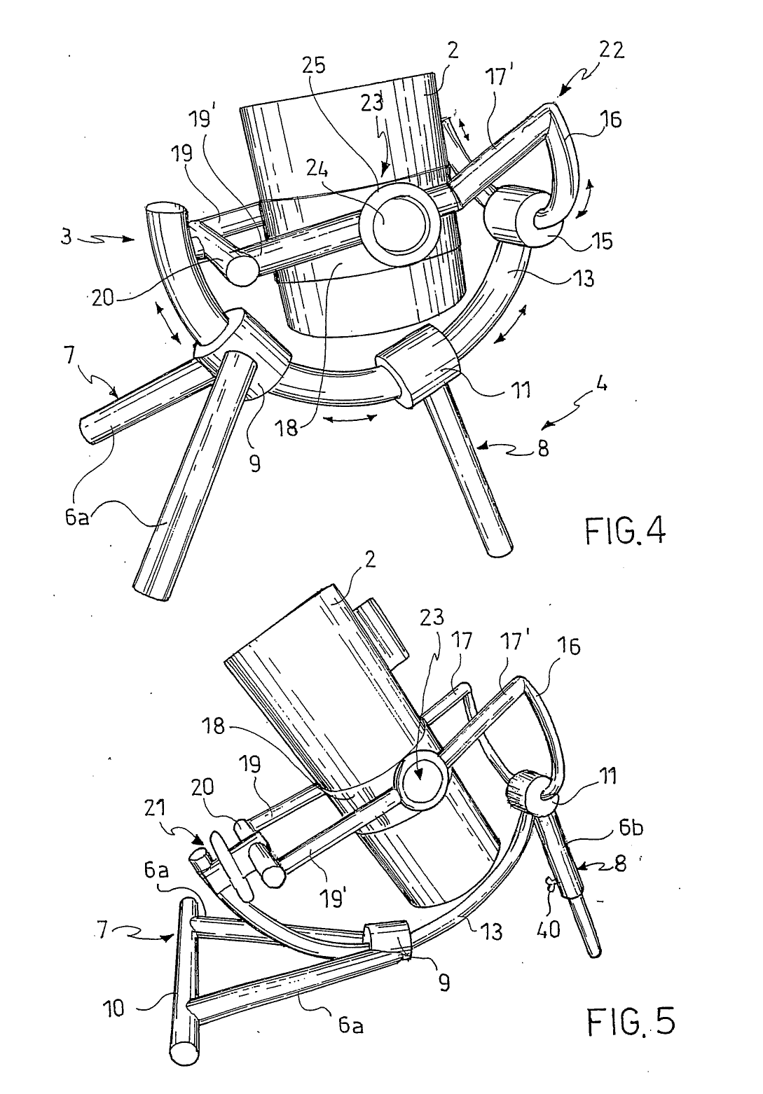

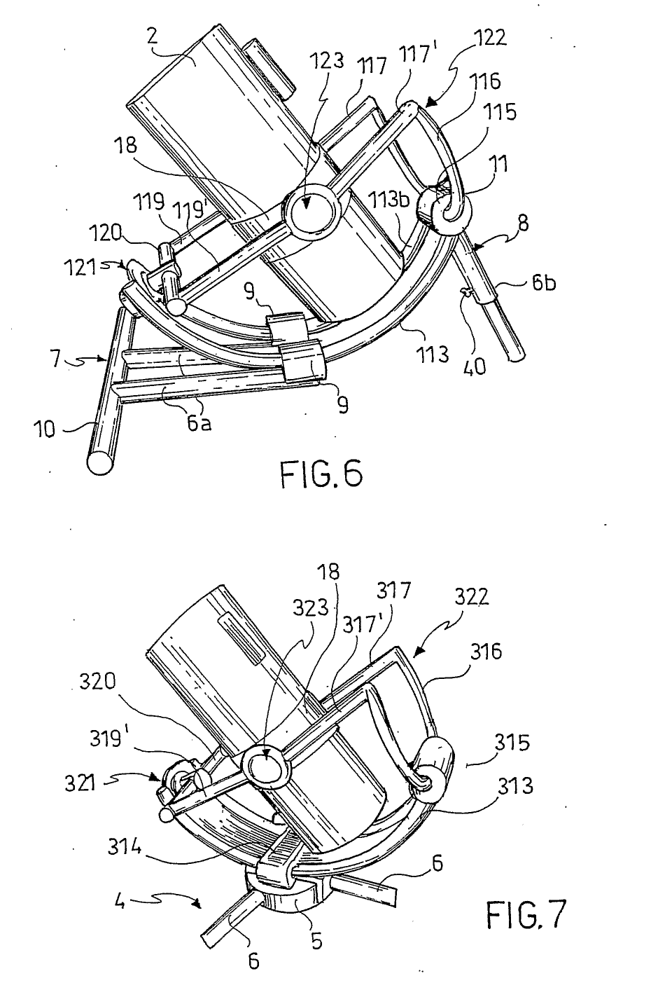

FIGS. 4, 5, and 6 show different embodiments of the rest means 4 comprising a first rest element 7 and a second rest element 8, which are separately connected to the mount 3. The first rest element 7 comprises means 9 for connection to the mount 3; two legs 6a starting therefrom (FIG. 4), which may be joined at both ends by a bar 10 that increases the rest surface thus favouring the system stability. The second rest element 8 comprises, in turn, means 11 for connection to the mount 3, and an extensible leg 6b. The extensible leg 6b has the function of allowing the rest means 4 to be adapted as a function of the different operating latitudes of the telescope, such as will be described in greater detail below. A typical embodiment of an extensible leg 6b is a telescopic leg (shown in FIGS. 5 and 6) with conventional stop means 40, such as a screw or clamping ring.

The variant of the rest means 4 as shown in FIG. 10 provides a base element 5 and legs 6, which are completely similar to the embodiment in FIG. 1. From one of the legs 6, however, there starts a pair of feet 6c, which are arranged in a V shape and rest on the two elements 613a, 613b of the mount 613, such as to increase the stability of the assembly.

The mount 3 is removably fixed to the base element 5 by means of a coupling element 12. This coupling element 12 is anchored to the base element 5 by means of suitable removable fixing means that are suitable to firmly stop the two elements, such as suitably dimensioned fixing screws. In the embodiment from FIG. 1, the coupling element 12 comprises a C-shaped bracket which is placed astride the base element 5.

The mount 3 is an equatorial mount and is characterized in that it comprises a circle-arc shaped primary rocking element 13, also said the “declination element”, which has the capacity of rotating about its geometrical center. The primary rocking element 13 is slidingly housed in a first sliding element 14, which is integral with the coupling element 12.

To an end of said declination element 13 there is fixed a second sliding element 15, which slidingly houses a secondary arc of circle-shaped rocking element 16, which is arranged on a plane perpendicular to that on which the declination element 13 is laid. The amplitude of this secondary rocking element 16 ranges between more than 180° and 200°, and the arc of circle has a greater diameter than the tube of the telescope 2.

At both ends of the secondary rocking element 16 there are fastened respective bars 17, 17′, which connect this secondary rocking element 16 to holding means 18 for the telescope 2. A second pair of bars 19, 19′ that ends at the other end with a connecting rod 20 joins these holding means 18 to the declination element 13, by means of pivoting joining means 21. A frame is thus formed 22, which due to these pivoting joining means and said secondary rocking element 16, allows the telescope 2 being held thereon to rotate about the right ascension axis.

The holding means 18 are pivotally connected to the bars 17, 17′, 19, 19′ of the frame 22 via articulation means 23 allowing the telescope 2 to rotate about the declination axis.

The bars 17, 17′ connecting the articulation means 23 at the ends of the secondary rocking element 16 are not aligned with the second bars 19, 19′, but they are inclined upwards. This configuration derives from the fact that the secondary rocking element 16 has an amplitude greater than 180°, such as to allow the telescope 2 to rotate about the polar axis along the whole 180° tract as required, without being hindered by the bulk of the bars 17, 17′ that would otherwise restrain its rotation.

The fact that said secondary rocking element 16 is arc of circle-shaped and has a greater diameter than the tube of the telescope 2 is dictated by the advantage of being able to accommodate the tube of the telescope 2, if the latter is longer than the bars 17, 17′, and thus allowing one to observe a wider celestial field. In fact, in operation (as will be described in greater detail below), the declination element 13 is rotated in order to cause the inclination of the frame 22 until the axis of the bars 19, 19′ is aligned with the polar axis. In this condition, the secondary rocking element 16 rotates about the polar axis and the observation of objects proximate to the Celestial Pole can be carried out only if the telescope 2 is capable of being aligned with the polar axis: this movement is allowed by the particular semicircular shape of the secondary rocking element 16 which creates an observation window in that difficult position.

The articulation means 23 shown in FIG. 1 comprise a pivot 24 integral with the holding means 18, which is pivotally coupled to an annular seat 25 integral with the bars 17, 19, which is provided with suitable bearings, such as thrust bearings. A similar structure will be naturally provided on the opposite side, at the bars 17′, 19′.

The holding means 18 are normally band-shaped and are preferably lined with a material that is suitable to dampen the vibrations and has a high friction coefficient, such as to prevent the tube of the telescope from sliding, even when it is in a much inclined position. This material will be, for example, an elastomer or felt or whatever is normally used in these applications.

The holding means 18 will be further structured such as to remove or cause the tube of telescope 2 to slide, according to the mounting/dismounting or adjustment requirements (e.g., in order to obtain a perfect balance of the optical parts on the support 1), and thus will comprise clamping means for the telescope 2. These means for clamping the telescope 2 to the support 1 are well known and therefore will not be described in greater detail below. For example, the holding means 18 can be formed by two semicircular bands which are hinged at one end thereof and comprise suitable clamping means at the other end thereof. Alternatively, the holding means 18 can be provided with clamping screws directly acting on the body of telescope 2. Other systems can be obviously used, without however departing from the scope of the present invention.

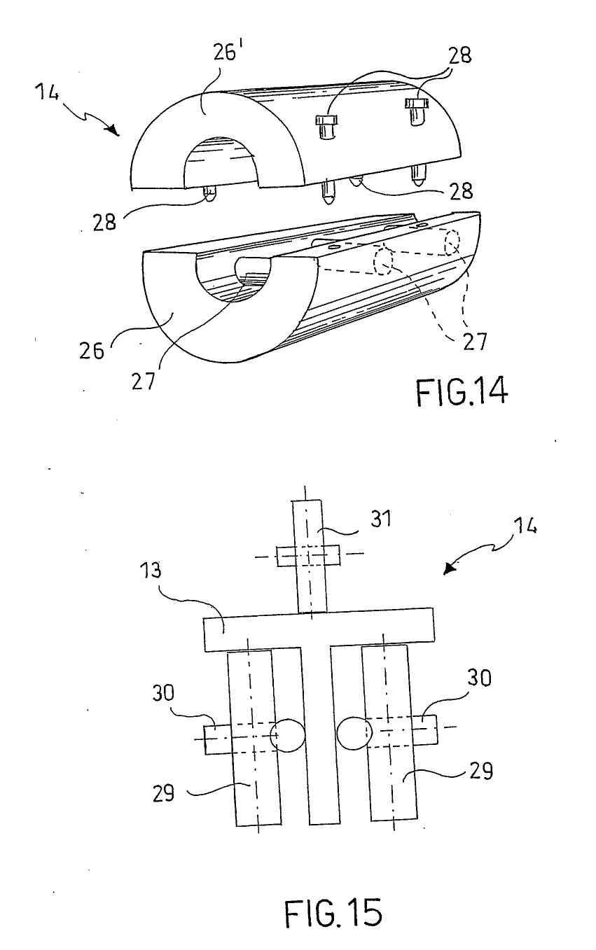

FIGS. 14 and 15 show two exemplary embodiments of the sliding elements 14, 15. In FIG. 14, a detail is shown of the primary sliding element 14. Said element 14 is tubular and formed by two hollow semi-cylinders 26, 26′, the sliding means 27 (such as rolls or balls) being arranged within at least one of them, such as to create a roller bearing, which is dimensioned according to the load to which they have to be subjected. Suitable clamping means, such as screws 28, provide to removably connect the two semi-cylinders 26, 26′. These clamping means further provide either to stop or loosen the sliding of the declination element 13, thereby allowing the same to be adjusted according to the latitude of the place in which the observation is carried out. To this purpose, to the declination element 13 there will be generally associated a graduated scale to allow the adjustment to be carried out at the desired latitude.

The primary (declination element) 13 and secondary 16 rocking elements shown in FIG. 1 have a round section. Elements can be used, however, which have a different section, such as elliptical, square, rectangular, and particularly T-shaped or I-shaped. With the latter two types a greater resistance will be obtained for the structure at a same area of the section. Accordingly, FIG. 15 shows an embodiment of the mechanism of the primary sliding elements 14 as seen in the crosswise direction, in which the primary rocking element 13 has a T-shaped section. The T-shaped element slides by being rested on a pair of wheels 29 that are placed on the two sides of the vertical portion and below the horizontal portions of the T-shaped element. The wheels are pivoted on shafts 30 which, at the inner end thereof facing the T-shaped element, house several balls, which are, in turn, slidingly abutted against the vertical portion of the T-shaped element. A further wheel 31 is placed above the horizontal portion of the T-shaped element, which provides to hold the T-shaped element pressed against the lower wheels 29. One or more sets of wheels 29, 31 may be arranged within the primary sliding elements 14.

The secondary sliding elements 15 for the secondary movable element 16 are substantially provided in the same way, but they do not require clamping means for stopping the movement of the rocking element 16. In fact, this secondary rocking element 16 will have to be free of sliding during observation.

The pivoting joining means 21 and the articulation means 23 will be preferably provided with friction means in order to allow positioning the telescope 2 in the desired position and holding the same in this position. Furthermore, an actuating knob and/or a graduated scale indicating the celestial coordinates can be associated to said pivoting joining means 21 and said articulation means 23.

Alternatively, said pivoting joining means 21 and said articulation means 23 will be provided with a suitable motor drive. The typology of motors to be used can be selected among alternating or direct current motors, stepping, brushless or toroidal motors, according to particular requirements, such as to allow both the pointing and automatic tracking of the celestial body to be observed. This application is particularly advisable in the field of astronomical photography.

The motors must preferably allow for reversible motion.

The motor to be applied to the RA axis (at the pivoting joining means 21) must be provided with such an operating speed to allow the RA axis to perform a full turn over a period of 23 hours, 56 minutes and 4.091 seconds, i.e. as long as the Earth takes to rotate about its own axis, to which the apparent motion of the celestial bodies is linked. During the observation of the apparent motion of a celestial body, the motor applied to the articulation means 23—the so-called declination motor—should remain still. Actually, due to small defects in the observation site, slight inaccuracies in the gears and other factors, declination corrections are required during star tracking. Therefore, on the one hand, the right ascension motor must be capable of accelerating or decelerating the motion according to the requirements, on the other hand, the declination motor must be capable of moving in the two directions in order to correct northbound or southbound drifts.

The support 1 of the invention may also comprise a command and control unit (CCU). With the traditional motors, the CCU calculates the position of the telescope from the number of revolutions of the motor. In case of paired stepping motors, the CCU counts the number of steps made in the two directions by each one of the motors and consequently determines the exact position adopted by the telescope. Brushless motors have a built-in CCU, which allows for an even more accurate control of the movements, speeds and positions. The CCU may have a memory in which the celestial coordinates of a list of observable celestial bodies are stored, which allows automatically pointing the telescope 2 to the selected object.

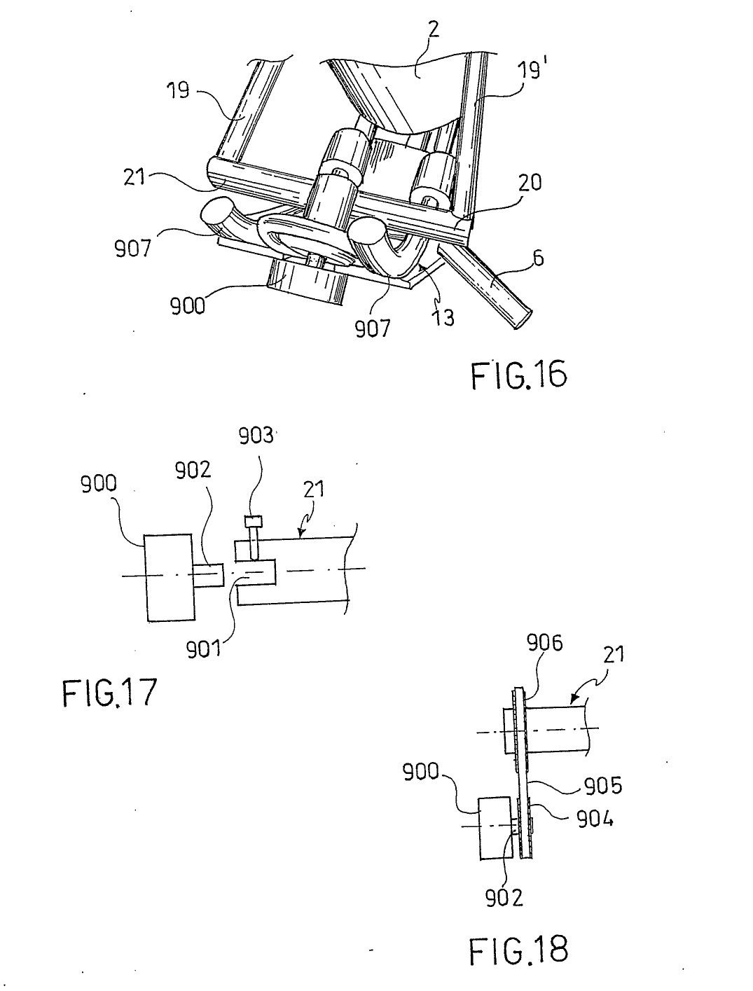

In FIGS. 16 and 17 there is shown a possible mounting of the right ascension motor 900 to the pivoting joining means 21. The shaft 902 of the motor 900 is co-axially fitted in a suitable seat 901 that is formed in the pivot of the means 21. Fixing means, such as a screw 903, provide to fix the shaft 902 to the seat 901. The motor 900 is thus supported by plates 907 that are fixed to the primary rocking element 13.

The motor drive may be similarly mounted to the declination axis, coaxially to the articulation means 23.

In FIG. 18 a different embodiment is shown, in which the motor 900 is offset relative to the pivoting joining means 21 (or the articulation means 23, not shown, respectively). In this case, the transmission of motion will occur by means of a suitable belt or chain 905 geared on pinions 904 that are associated to the shaft 902 of motor 900 and to the pivot of the means 21, respectively.

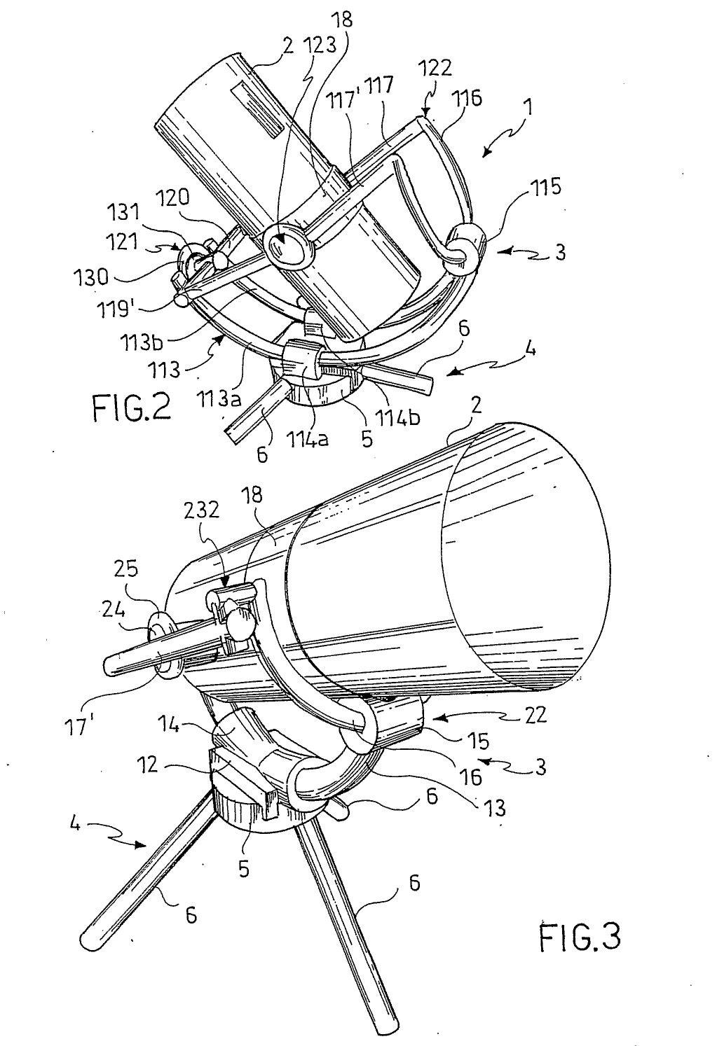

In FIG. 2 there is shown a second embodiment of the support 1 of the invention. In this embodiment, the primary rocking element (declination element) 113 consists of two arc of circle-shaped bars 113a, 113b sliding within respective primary sliding elements 114a, 114b. At the one end, the arc of circle-shaped bars 113a, 113b are joined to the secondary sliding element 115, while at the other end, they are fixed to an annular element 130. The annular element 130 is pivotally coupled—by means of suitable bearings—to a pivot 131 that is connected to the frame 122, particularly to the connecting rod 120 of the bars 119′ and 119 (not seen in the perspective view of FIG. 2)

All the remaining parts of the support 1 are perfectly similar to the corresponding parts as described above.

The advantage of this embodiment is that it provides the support with greater firmness and furthermore it allows for a comfortable visual access even when Cassegrain or catadioptric telescopes are used, with rear eyepiece.

In FIG. 3 a different embodiment of the mount 3 is shown. In this embodiment, the bars 17′ and 19′ are aligned such as to form an individual bar. The same happens with bars 17 and 19, not seen in the figure. At the end proximate to the secondary rocking element 16, the bars 17, 17′ comprise a joint 232 substantially having the shape of a reversed L, which is arranged perpendicular to said bars 17, 17′ such as to be joined to the ends of the secondary rocking element 16. Thereby, the arc of circle of said element 16 can have an amplitude greater than 180°, thus allowing the element 16 to perform the 180° full revolution, as required.

The embodiments in FIGS. 4, 5 and 6 (already described above) differ from the versions in FIGS. 1 and 2 because of a different configuration of the rest means. In these embodiments, the means 9, 11 connecting the primary rocking element 13 to the rest means 7, 8 also comprise the sliding means described above.

In FIG. 7 a different embodiment is shown, in which the primary rocking element 313 is formed by a arc of circle-shaped band. The sliding element 314 will be consequently shaped. The greater contact surface of this version provides the support 1 with greater firmness.

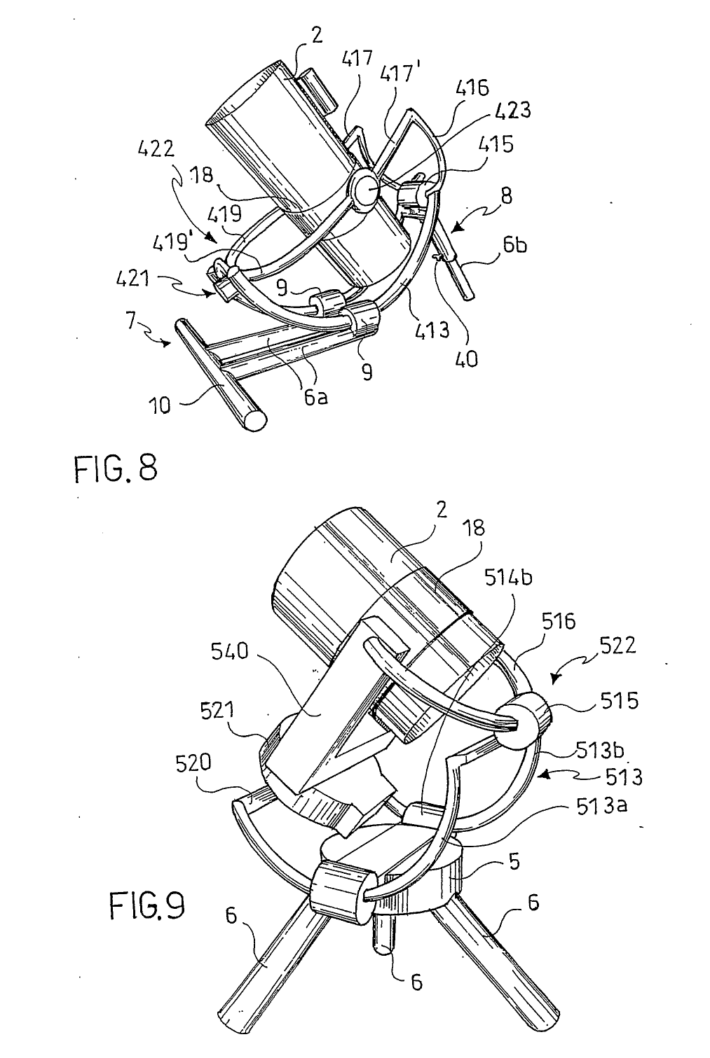

The version shown in FIG. 8, besides comprising the rest means 7, 8 from FIG. 6, also has a different shape of the bars 419, 419′ for connection with the pivoting joining means 421. In this embodiment, in fact, the connecting rod 20 has been eliminated and the bars 419, 419′ have been bent in the shape of an arc of circle such as to be joined with said means 421. This solution reduces the size of the frame 422, thereby preventing the same to interfere, during the rotation about the RA axis, with the primary rocking element 413. In fact, it should be taken into account that the distance between the bars 17, 19 and 17′, 19′ is dictated by the diameter of the telescope 2 and that, with great diameters, the connecting rod 20 can collide with the declination element during the rotation of the frame. In the version in FIG. 8, as the limit for the telescope 2 diameter results from the diameter of the primary rocking element 413, it is greater when the bars 419, 419′ are arc of circle-shaped. It may also be provided that the connecting rod is arc of circle-shaped or V-shaped, still for bulk reduction purposes; or that the bars 419, 419′, instead of adopting a arc of circle-shaped profile, are joined according to a V-shaped profile.

FIG. 9 shows a further embodiment of the support 1 of the invention, which is particularly adapted to a traditional fork mount. In this version, the telescope 2 is mounted on a conventional fork-like support 540, which, in turn, is connected, by means of pivoting joining means 521 to the rod 520 and hence to the primary rocking element 513. The other end of this primary rocking element 513 is fixed, such as in the versions above, to the secondary sliding element 515 of the secondary rocking element 516. The ends of the latter are fixed to the fork-shaped support 540 proximate to the ends of the fork's arms. This embodiments facilitates using the large sized Dobson telescopes, which are generally provided with altazimuth fork mounts, which—in order to be desirably turned into equatorial—would require a cantilevered equatorial head with consequent unbalancing of the loads and increase in vibrations. In fact, the fork mount suitable to the support of the invention has the advantage over the traditional equatorial head that it moves the barycentre of the system in the central position, without requiring the provision of counterweights or cantilevered parts.

The embodiment shown in FIG. 10 is a simplified version, in which the frame 622 is pivoted at the ends of the primary rocking element 613 by means of pivoting joining means 621, 651. Said frame 622 consists of connecting rods 620, 650 to which the bars 617, 619 and 617′, 619′ are connected. As in the versions above, these bars 617, 619 and 617′, 619′ are connected with the articulation means 623 allowing the telescope 2 to rotate about the declination axis. In this embodiment, the secondary rocking element has been omitted to the detriment of the freedom of observation in the region proximate to the Celestial Pole. However, the support retains the considerable advantage of perfect weight balance.

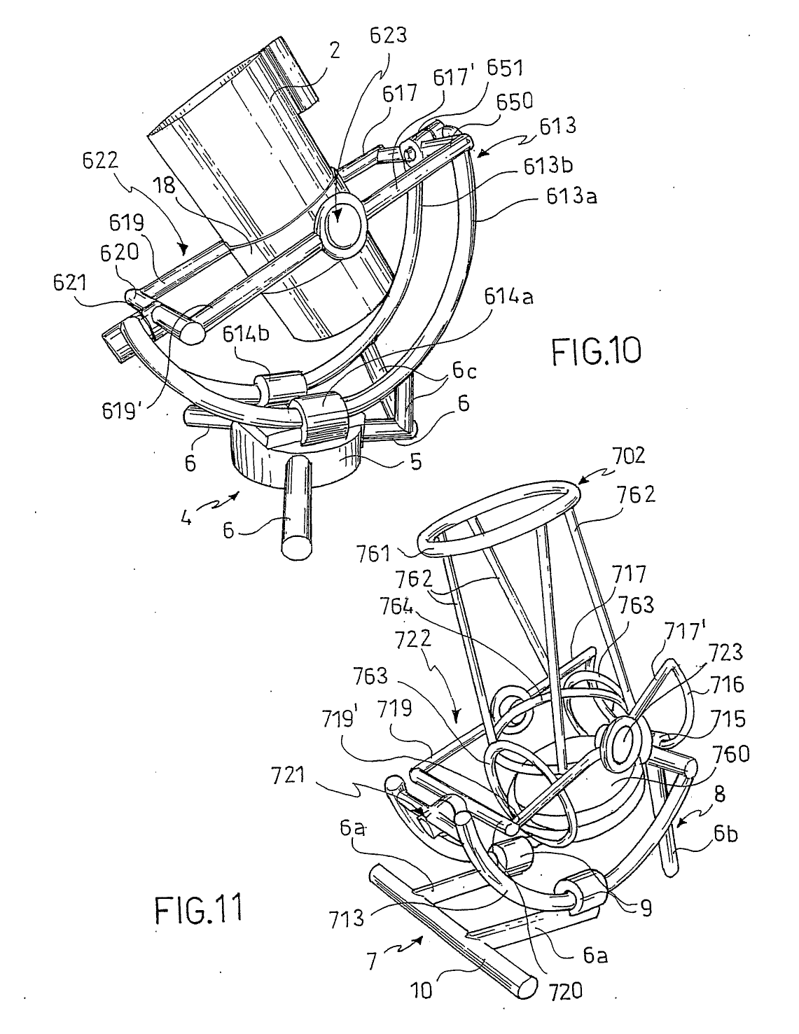

In FIG. 11 a further embodiment of the invention is shown, in which the support 1 is completely similar to that in FIG. 6, while the structure of the telescope 702 is substantially different. In this version, in fact, the telescope 702 is reduced to a frame structure consisting of a support base 760 for the primary mirror and a support ring 761 for the secondary mirror (not shown), which are joined by rods 762 and reinforcement rings 763. Another ring 764 that is arranged in the intermediate position between the support base 760 and the support ring 761 provides to connect the telescope 702 to the articulation means 723.

In a preferred embodiment, the support 1 of the invention will comprise latitude fine adjusting means. As said above, the primary rocking element (or declination element) 13 has a function of setting the latitude of the place in which the observation is carried out, by allowing the polar axis of the mount to be inclined to the extent required. This is, however a course adjustment.

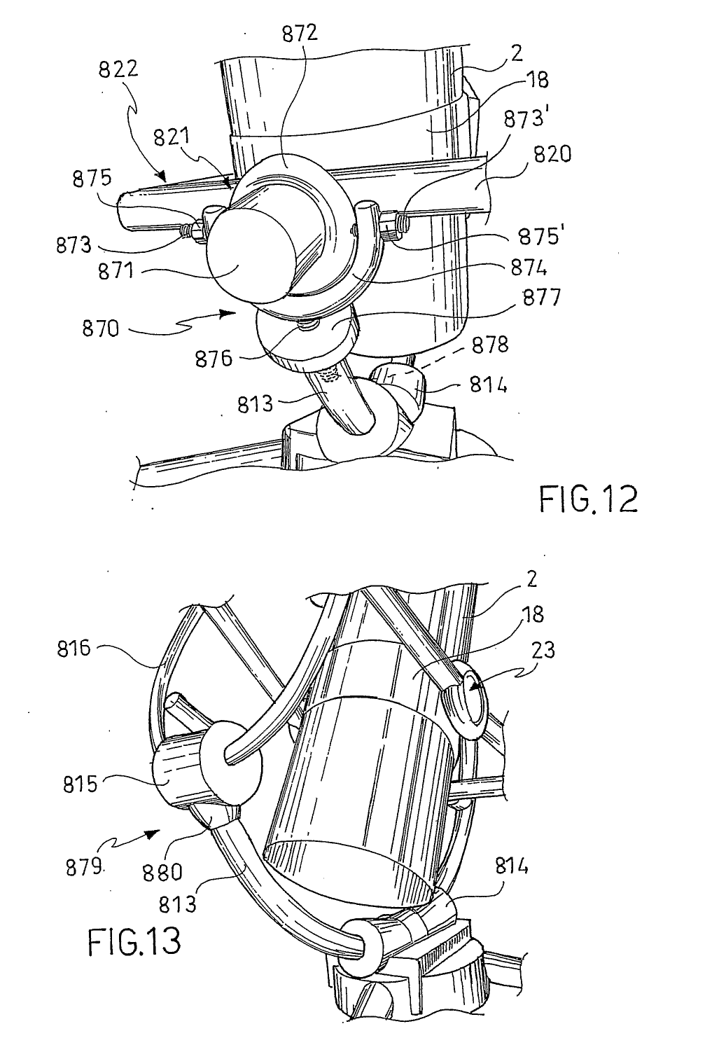

In order to obtain an accurate latitude setting, the support 1 may thus comprise the fine adjusting means 870. As shown in FIG. 12, the connecting rod 820 of the bars 19, 19′ (not shown in the figure) comprises, in the middle, a pivot 871 that is aligned with the RA axis. The pivot 871 is pivotally housed in a bearing 872, preferably a roller bearing, more preferably a thrust roller bearing. This bearing 872 is connected to the declination element 813 by means of said fine adjusting means 870 that will be described below.

On both sides of the bearing 872, along an axis perpendicular to and intersecting the RA axis, there are arranged two threaded bars 873, 873′ that pass through a support element 874, which in the example is shaped as a semicircular fork, but may have an annular shape or any other shape suitable to encompass the bearing. The support element 874 will thus comprise two threaded holes for the threaded bars 873, 873′ to pass and act therethrough. The threaded bars 873, 873′ pass through the support element 874 and emerge therefrom such as to be coupled to respective left-right adjusting knobs 875, 875′, which in the example are embodied by nuts. When the one of said knobs is unscrewed and the other is screwed, and vice versa, a horizontal displacement will be obtained for the bearing 872 and frame 822.

To the support element 874 there is fastened, along an axis perpendicular to and intersecting both RA axis and the axis on which the threaded bars 873, 873′ lay, a threaded bar 876, the free end of which is coupled to a threaded hole which passes through a high-low adjusting knob 877. A further threaded bar 878 being fixed to an end of the declination element 813 is coupled to the same threaded hole of the high-low adjusting knob 877, though on the opposite side. The threaded bars 876, 878 have inverse threads, i.e. a left-hand one and a right-hand one, such that when the knob is rotated in one direction, a threaded bar will be unscrewed and the other will be screwed, and vice versa. When the high-low adjusting knob 877 is unscrewed/screwed, a vertical displacement will be then obtained, in the two directions, for the element 874, bearing 872 and frame 822 therewith.

Suitable graduated ring-nuts, preferably with vernier reading systems indicating the degrees and/or minutes and/or seconds of latitude, will be suitably associated with the adjusting knobs 875, 875′, 877.

In order to allow performing the high-low (vertical) and left-right (horizontal) adjusting movements as described above without torsions occurring in that part of the RA axis that is exposed to the North, an articulation 879 is required to be provided for the declination element 813 at the connection with the sliding element 815 for the secondary rocking element 816. As shown in FIG. 13, this articulation 879 can comprise a ball 880 being arranged at the end of the declination element 813, which is housed in a suitable spherical seat that is formed in the sliding element 815. Each type of joint, either a ball joint or the like, may be used which is suitable to allow this movement.

Accordingly, the fine adjusting means 870, in addition to connecting the frame 822 of the mount to the declination element 813, also allow the latitude—and thus the inclination of the polar axis—to be accurately set as follows. First of all, the latitude is coarsely set by positioning the plane of the element 13 in coincidence with the plane of the local meridian, by causing the declination element 813 to slide within the corresponding sliding element 814 and locking the same in this position such as discussed above. At this stage, when the high-low adjusting knob 877 is suitably rotated, the support element 874 and thus the frame 822 will be moved away or close from/to the declination element 813 according to a vertical movement. On the other hand, when the left-right adjusting knobs 875, 875′ are screwed/unscrewed, a horizontal movement of the frame 822 will be obtained relative to the support element 874 and thus the declination element 813. The latitude setting can be thus finely adjusted.

The support 1 may also comprise a bubble-level positioning means 30. This bubble-level positioning means 30 can be associated with the support means 4 or coupling element 12 (such as shown in FIG. 1) or any other part that remains motionless upon operation.

The support 1 can be made of any material commonly used in this applications, particularly iron, steel and/or aluminium. The perfect balance of the weights to be obtained with the inventive support, however, allows selecting lightweight materials, such as composite materials made of carbon fiber or light metals.

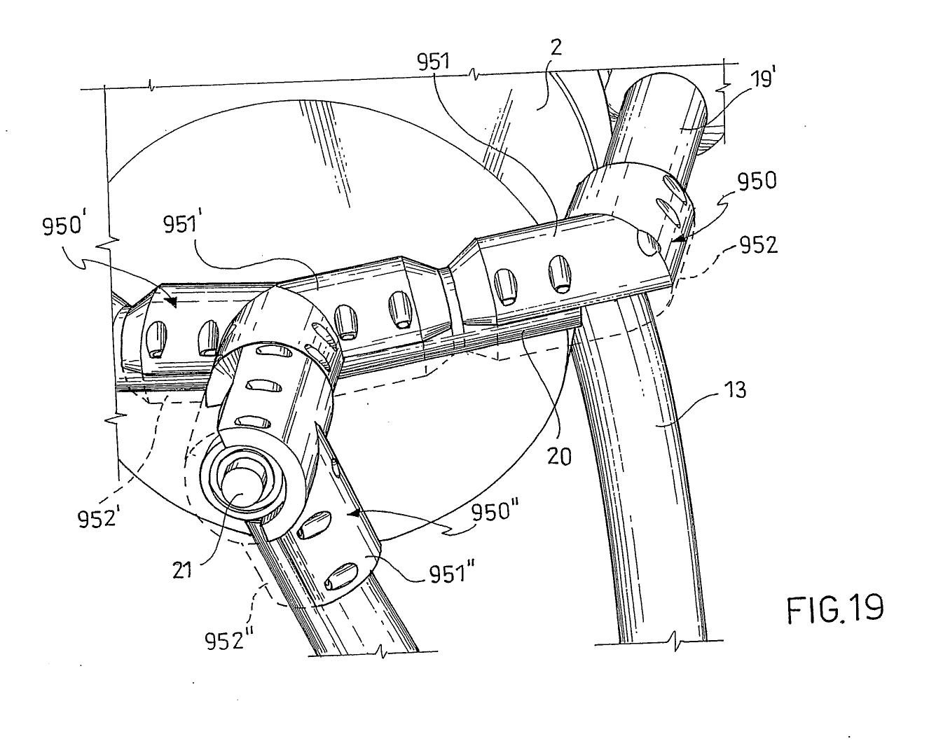

In a different embodiment of the invention, a detail thereof being shown in FIG. 19, a modular support is provided, i.e. the several elements composing the mount 3 (primary 13 and secondary 16 rocking elements, bars 17, 17′, 19, 19′, connecting rod 20, pivoting joining means 21, articulation means 23, etc.) are assembled by means of conventional removable joining elements 950, 950′, 950″, which are L-, V-, T-shaped according to the various mounting requirements. These joining elements 950, 950′, 950″ will be formed, for example, by two half-shells 951, 952; 951′, 952′; 951″, 952″ to be assembled by means of setscrews, such as to enclose and lock the ends of two pieces to be joined. The whole structure can thus be easily dismounted, thereby improving transportation, or built in modules according to the requirements. For example, the telescope diameter may be changed without requiring a different support, by simply replacing those elements that are most suitable to the new size.

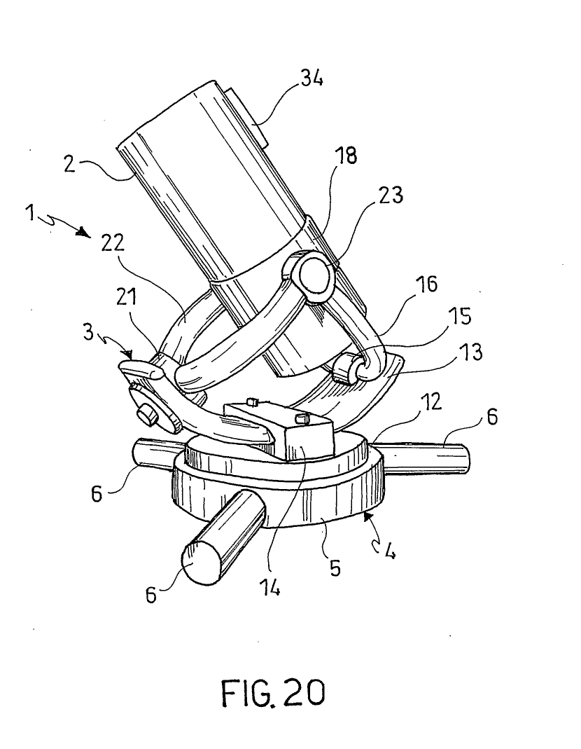

In accordance with the embodiment in FIG. 20, the arc of circle of the primary rocking element 13 has a reduced amplitude as compared with the embodiments described above. Particularly, it has an amplitude slightly greater than 90°. Due to the mutual dimensions of the pivoting joining means 21, primary sliding elements 14 and secondary sliding elements 15, the amplitude of the primary rocking element 13 is the minimum amplitude allowing 90° rotation to the primary rocking element 13.

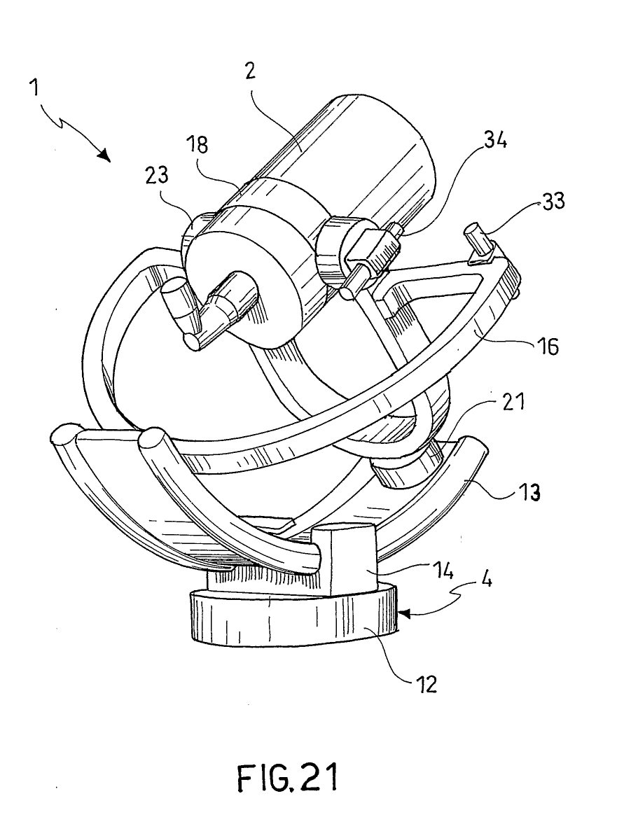

In accordance with the embodiment in FIG. 21, the primary rocking element 13 has a amplitude slightly greater than 90°, similarly to the embodiment in FIG. 20, and is formed by a band, similarly to the embodiment in FIG. 7.

The section of the band forming the rocking element can have varying shapes according to the particular requirements. For example, it can have an elliptic shape, such as in the example in FIG. 20, it can be T-shaped such as in the example in FIG. 15 or it can take other shapes ensuring effective guiding and clamping and suitable mechanical rigidity.

In the embodiment in FIG. 21, the band section takes the shape of an elongated 8, with two round lobes at the ends and a substantially flat central area. This configuration results to be particularly effective in terms of mechanical rigidity and ease of guide during the sliding step, and ease of locking.

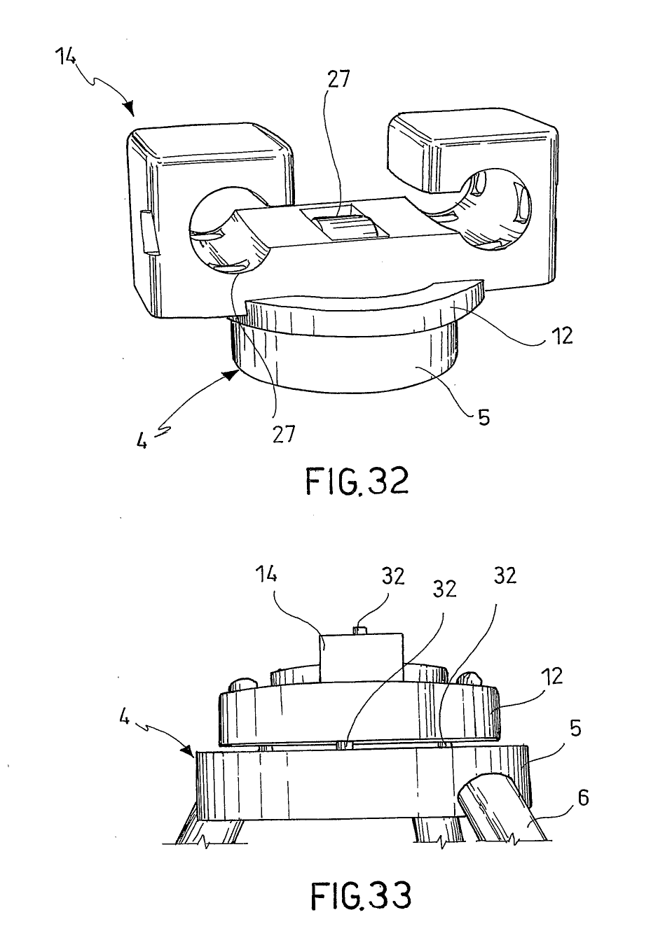

FIG. 32 shows a detail of the sliding element 14 in FIG. 21, dedicated to a band-like rocking element with an elongated 8-shaped section. This sliding element has the characteristic of considerably reducing the relative dimensions and possible interference among the connecting elements of the various components of the mount 3. As may be noted in FIG. 32, in fact, the sliding element 14 is shaped such as to partially encompass the band of the rocking element 13 without obstructing the central area thereof. Thereby, on the one side, the effectiveness of clamping and guiding can be maintained during sliding, and on the other side, the interference with the pivoting joining means 21 and secondary sliding elements 15 mounted in the middle of the band can be avoided.

This configuration of the primary sliding element 14 allows further reducing the development of the arc of circle of the primary rocking element 13. As may be seen in FIG. 21, the arc of circle of the primary rocking element 13 has an amplitude of substantially 90°.

This reduction in the amplitude of the arc of circle of the primary sliding element 14 allows easier observation with Cassegrain or catadioptric telescopes, which have the eyepiece placed in the rear area (such as the one in FIG. 21).

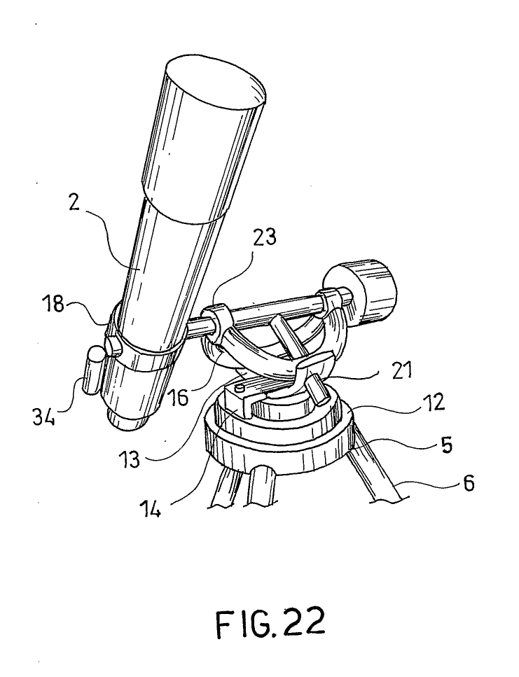

FIG. 22 shows the use of a support according to the invention for the cantilever side mounting of a telescope having such a size and/or configuration that cannot be housed within the mount 3. This condition can easily occur with refractor telescopes (with longer optical tube at the same focal length) or with reflector telescopes having a barycentre particularly shifted forward.

As may be seen, the support according to the invention allows an easy use of these telescopes, with the provison that a counterweight is provided that is suitable to balance the cantilevered weight. Thereby, the system barycentre is brought back to the middle of the rest means 4, the condition in which the support 1 according to the invention ensures best performance. Of course, the counterweight can comprise, instead of a simple ballast, an auxiliary telescope and/or other equipment used for observation.

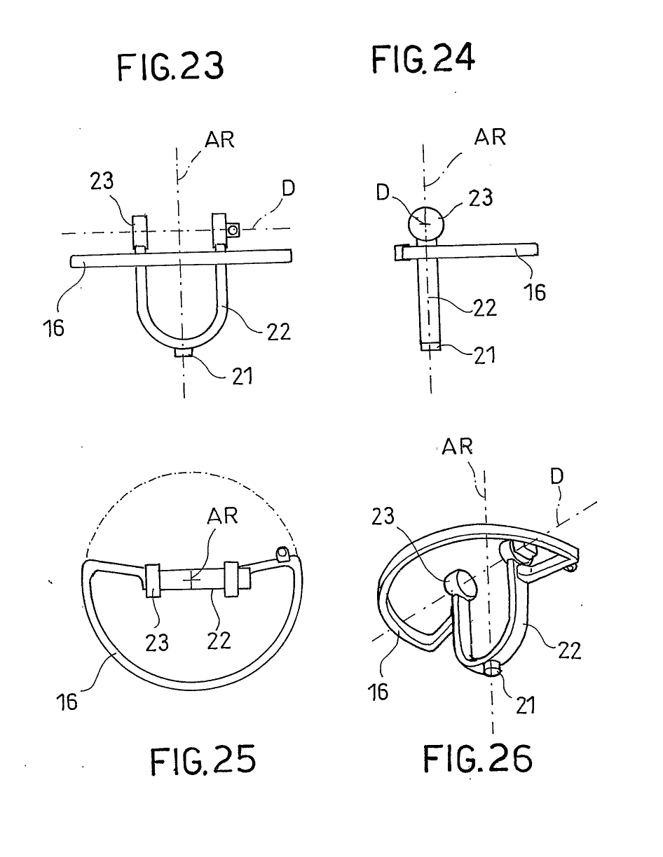

In FIGS. 23 to 26 the assembly is shown consisting of the secondary rocking element 16 and frame 22. The pivoting joining elements 21 and the articulation means can also be seen, which are at least partially mounted.

As may be noted, the arc of circle of the secondary rocking element 16 has an amplitude slightly greater than 180°. Due to the mutual dimensions of the primary sliding elements 14 and secondary sliding elements 15, the amplitude of the secondary rocking element 16 is the minimum amplitude allowing 180° rotation to the secondary rocking element 16.

The figures annexed herein, particularly FIG. 24, show that the plane in which the secondary rocking element 16 is laid and rotated is perpendicular to the axis defined by the pivoting joining means 21 about which the frame 22 rotates (right ascension axis or axis AR, which will coincide with the polar axis, with the telescope properly oriented).

It should be further noted how, see particularly FIG. 25, the axis AR passes exactly through the centre of the circle about which the secondary rocking element 16 is developed and rotated.

The annexed figures, particularly FIG. 23, further show that the axis defined by the articulation means 23 about which the holding means 18 are rotated (declination axis or axis D) is perpendicular to the axis defined by the pivoting joining means 21 about which the frame 22 is rotated (axis AR).

The mutual perpendicularity as defined above and the axis AR passing through the centre of the secondary rocking element 16 are critical for proper operation of the support 1 and must be set upon manufacture with the utmost precision.

If this perpendicularity is ensured, the assembly consisting of the secondary rocking element 16 and frame 22 can adopt different configurations.

In the embodiment in FIGS. 23 to 26, for example, it may be seen that the frame 22 takes the shape of a U-shaped fork.

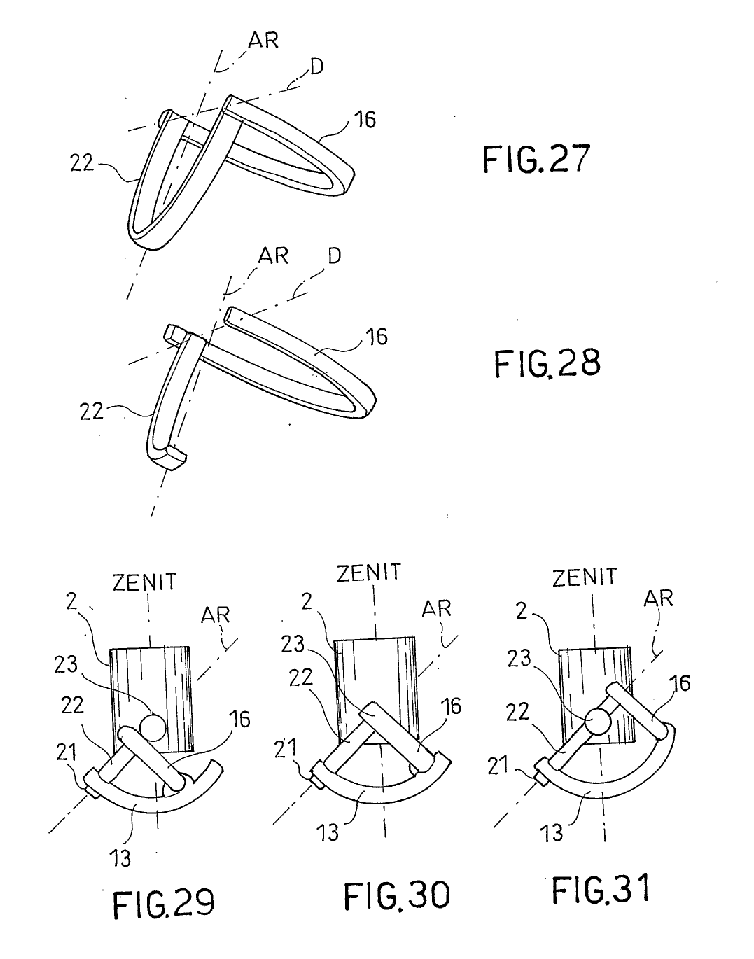

In the embodiment in FIG. 27, for example, it may be seen that the frame 22 takes a rounded shape, similarly to the secondary rocking element 16.

In the embodiment in FIG. 28, for example, it may be seen that the frame 22 takes an asymmetric simplified shape, similar to the shape in FIG. 27, in which one of the two arms is omitted. This configuration allows further ease of observation as it permits an easier access to the rear area of the telescope 2.

In the embodiment in FIG. 30, for example, it may be seen that the secondary rocking element 16 meets the frame 22 exactly in correspondence with the axis D.

In the embodiments of the adjacent FIGS. 29 and 31, on the other hand, the secondary rocking element 16 meets the frame 22 in an offset position, toward the Equator or Pole, relative to the axis D, respectively.

FIG. 33 shows a particular embodiment of the rest means 4 and base element 5 and coupling element 12 thereof. They are configured such as to be capable of rotating relative to each other in a controlled manner.

In accordance with possible embodiments, the coupling element 12, rotating relative to the base element 5, further comprises a compass and/or a GPS satellite detection system.

Furthermore, in FIG. 33 are shown adjusting means 32 suitable to change the plane of the coupling element 12 relative to the plane of the base element 5 in a controlled manner, particularly suitable to position the plane of the coupling element 12 parallel to the plane of the local horizon.

The adjusting means 32 comprise, for example, three screws located about a circumference, spaced 120° away from each other, and height-adjustable independently of one another.

In accordance with an embodiment, the coupling element 12, rocking relative to the base element 5, comprises bubble-level positioning means 30.

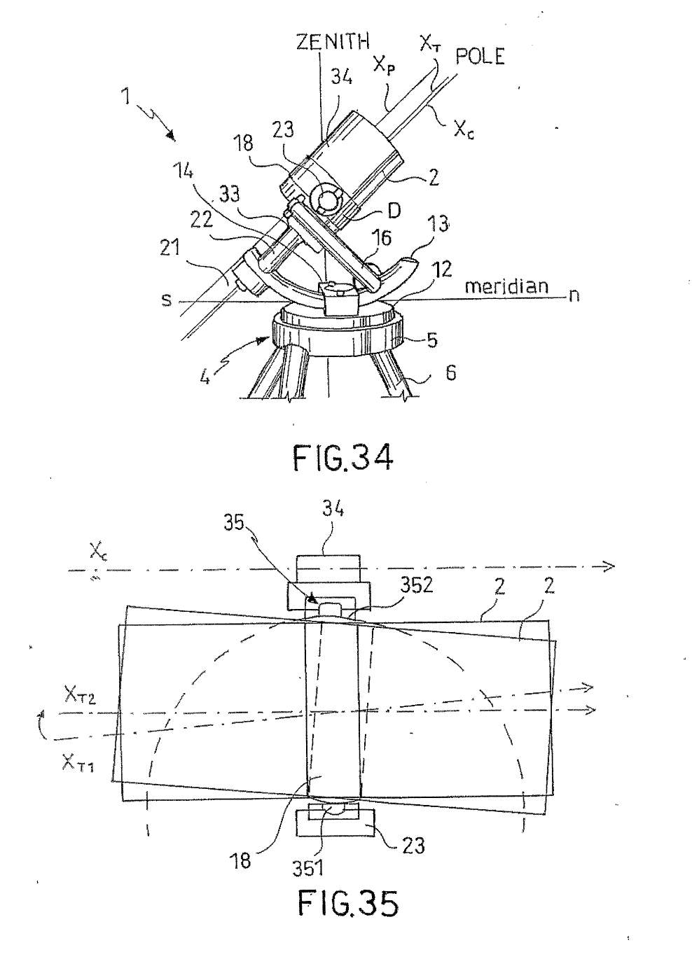

In accordance with several embodiments, such as those in FIG. 21 or 34, the telescope support 1 comprises a polar telescope 33 and a finder telescope 34.

The polar telescope 33 is integral with the mount 3 and has the optical axis X_{P} aligned upon manufacture with the axis AR defined by the pivoting joining means 21 and the centre of the circle of the secondary rocking element 16. Particularly, in the embodiment in FIG. 34, the polar telescope 33 is integral with the secondary rocking element 16.

The alignment upon manufacture ensures the maximum geometrical precision. When the telescope is properly oriented, the polar telescope 33 will remain constantly pointed to the astronomical pole.

The finder telescope 34 is preferably integral with the holding means 18 and has the optical axis X_{C} aligned upon manufacture with the geometrical axis of the housing for the telescope 2 formed by the holding means 18. The alignment upon manufacture ensures achieving the maximum geometrical precision. When the telescope is properly oriented, the finder telescope 34 will remain constantly aligned with the telescope 2.

In the particular configuration adopted by the support 1 in FIG. 34, the telescope 2, polar telescope 33 and finder telescope 34 are simultaneously aligned with the astronomical pole.

To cause the polar telescope 33 to point to the astronomical pole, it is sufficient to properly orientate the support 1. An elementary orientation sequence of the support will be described below.

To cause the finder telescope 34 to be aligned with the polar telescope 33, it is sufficient to rotate the holding means 18 about the axis D until the astronomical pole is framed in the center of the visual field of the finder telescope 34.

The alignment of the telescope 2 results to be more complicated. In fact, the telescope 2 is an object physically separated from the support 1, interchangeable and of a quality not defined beforehand.

Accordingly, it may occur that, when the telescope is being mounted, the geometrical axis of the tube does not exactly coincide with the geometrical axis of the housing as defined by the holding means 18. This error can occur to different extents from time to time.

It may also occur that the telescope 2 is not perfectly collimated. Incidentally, a telescope is said to be collimated when the optical axis X_{T} coincides with the geometrical axis of the tube (or other support of the optics). Any collimation error generates a constant systematic error.

Finally, it may happen that the two errors described above occur together.

To avoid this serious drawback, the support 1 according to the invention comprises means 35 for aligning the optical axis X_{T} of the telescope 2 with the optical axis X_{C} of the finder telescope 34.

As those skilled in the art may certainly appreciate, this structure is a reversal of prior art established concepts, where a finder telescope is always attempted to be aligned with a telescope. With this known method, the system remains affected by all the systematic errors described above. These errors will require continuous adjustments throughout the observation, and will prevent, beforehand, the possibility of correctly carrying out an automatic tracking of a celestial body in its apparent motion.

With reference to FIG. 35, the procedure for aligning the optical axis X_{T} of the telescope 2 with the optical axis X_{C} of the finder telescope 34 is schematically described below.

The telescope 2 in FIG. 35 is exaggeratedly uncollimated. As may be seen, the optical axis X_{T} is clearly not parallel to the geometrical axis of the optics tube. Accordingly, against a proper orientation of the tube, the optical axis initially takes a direction X_{T1} that is clearly wrong. The movement obtained by means of the alignment means 35, indicated by the arrow, allows bringing the optical axis in the direction X_{T2}, aligned with the reference axis X_{C}.

The alignment means 35 in FIG. 35 comprise a rotational centre that is proximate to and integral with the one of the articulation means 23 and a fine translation apparatus proximate to the other of the articulation means 23. The rotational centre can, for example, comprise a spherical joint 351, whereas the fine translation apparatus can, for example, comprise a coupling 352 between a rack and a worm screw.

After the support 1 has been properly oriented, the polar telescope 33 and finder telescope 34 properly point the astronomical pole. By means of the alignment means 35, the telescope 2 can be also aligned therewith. After the alignment has been thus obtained, the system is free of systematic errors. The observation and automatic tracking of a celestial body may be carried out without further pointing corrections.

One of the possible methods for properly orienting a support 1 according to the invention of the type shown in FIG. 21 or 34 will be described below.

First of all, the observation system consisting of the telescope 2 and support 1 according to the invention has to be arranged according to the steps of:

fastening the telescope 2 in the holding means 18 at the barycentre of the optics tube;

set the mount 3 in the usage configuration.

The method for achieving a proper pointing with the thus arranged observation system comprises the steps of:

firmly positioning the rest means 4 such as to obtain that the plane defined by the base element 5 is approximatively horizontal;

operate the adjustment means 32 such as to obtain that (optionally with the aid of the bubble-level positioning means 30) the plane defined by the coupling element 12 is preferably horizontal;

rotate the coupling element 12 relative to the base element 5 such as to obtain that (with the aid of the compass or other systems such as spherical astronomy calculation techniques) the primary rocking element 13 is parallel to the local meridian, particularly with the pivoting joining means 21 toward the Equator and the secondary rocking element 16 toward the astronomical pole (North Pole in the example in FIG. 34);

rotate the primary rocking element 13 within the primary sliding element 14 thereof, such as to obtain that the axis AR takes an inclination relative to the horizon which is approximatively equal to the latitude of the observation place;

operate the fine adjustment means 870 such as to precisely align the axis AR to the polar axis, for example by framing the astronomical pole by means of the polar telescope 33;

preferably, pointing the finder telescope 34 to the astronomical pole such as to align the geometric axis X_{G} of the housing of the telescope being defined by the holding means 18 also to the polar axis;

preferably, acting on the alignment means 35 such as to align also the optical axis X_{T} of the telescope to the polar axis.

After the steps described above have been carried out, the telescope is properly pointed to the astronomical pole. From this position, it can be properly pointed to any celestial body, simply by setting the coordinates thereof.

The advantages of the support for telescopes being the object of the present invention are clear and have been partially set forth above.

Particularly, the support 1 associates a perfect weight balance, which is normally typical with English mounts, with easy transportability which characterizes the fork or German equatorial mounts; which transportability is obtained both due to the lower weight and the adaptability to different latitudes that derives from the adjustability of the primary rocking element.

The lower weight and small bulk of the support, which is due to the particular compact structure, without cantilevered parts, allows also relatively large-sized telescopes to be also transported, such as those with mirrors of 50 cm diameter and more, which are normally intended for fixed stations.

The support of the invention does not require equatorial heads, balance counterweights or basement overweight, with a consequent saving of material and costs.

It will be appreciated that only some specific embodiments of the support for telescopes being the object of the present invention have been described herein, to which those skilled in the art will be able to make any and all modifications necessary for its adjustment to specific applications, without however departing from the scope of protection of the present invention.

For example, the primary rocking element may also not have the shape of an arc of circle, but for example any fork or squared C shape. In this case, the rocking effect will be performed by fastening this element to a suitable rocking support, such as a roller or other known rocking system. This solution may be obviously applied also to the arc of circle-shaped primary rocking element as described above or the secondary rocking element, regardless of the same having the shape of an arc of circle or any other shape.

1-67. (canceled)

68. A support for a telescope comprising a mount and means for resting said mount on the ground, wherein said mount comprises a primary rocking element allowing one to set the latitude of the observation place, to said primary rocking element being pivotally fastened a frame which allows the movement of the telescope about the right ascension axis and/or about the declination axis.

69. The support for a telescope according to claim 68, wherein said primary rocking element is circle-arc shaped.

70. The support for a telescope according to claim 68, wherein said primary rocking element is movable within at least one primary sliding element.

71. The support for a telescope according to claim 68, wherein said primary rocking element comprises two arc of circle-shaped bars sliding within respective sliding elements.

72. The support for a telescope according to claim 68, wherein the primary rocking element is formed by a arc of circle-shaped band.

73. The support for a telescope according to claim 68, wherein said frame is pivoted, by means of pivoting joining means, to the ends of the primary rocking element, said frame comprising connecting rods to which the bars are connected; said bars being connected to articulation means that allow the telescope to be rotated about the declination axis.

74. The support for a telescope according to claim 68, wherein said frame comprises a secondary rocking element that is arranged on a plane perpendicular to said primary rocking element.

75. The support for a telescope according to claim 74, wherein said secondary rocking element is arc of circle-shaped and is movable within at least one secondary sliding element, said at least one secondary sliding element being fastened to said primary rocking element.

76. The support for a telescope according to claim 75, wherein said arc of circle-shaped secondary rocking element has an amplitude of more than 180°, preferably ranging between more than 180° and 200°, and a diameter greater than the diameter of said telescope.

77. The support for a telescope according to claim 74, wherein said telescope is mounted via holding means on a fork-like support, which in turn is connected by means of pivoting joining means to a connecting rod and thus to the primary rocking element; the other end of said primary rocking element being fixed to the secondary sliding element.

78. The support for a telescope according to claim 74, wherein to said secondary rocking element there are fastened respective bars for connection to holding means for the telescope, a second pair of bars joining said holding means with a connecting rod that is hinged to said primary rocking element via pivoting joining means allowing said frame to rotate about the right ascension axis.

79. The support for a telescope according to claim 78, wherein said bars of the frame are pivotally connected to said holding means via articulation means allowing the telescope to be rotated about the declination axis.

80. The support for, a telescope according to claim 77, wherein said holding means are structured such as to be able to remove or cause the tube of the telescope to slide and comprise clamping means for said telescope.

81. The support for telescope according to claim 70, wherein said primary and, when provided, secondary sliding elements comprise sliding means, such as rolls or balls, such as to form a roller bearing.

82. The support for a telescope according to claim 81, said primary sliding element comprising clamping means for stopping or loosening the sliding movement of the primary rocking element.

83. The support for a telescope according to claim 68, wherein said primary and/or secondary rocking element, when provided, has an elliptical, square, rectangular, T- or I-shaped section.

84. The support for a telescope according to claim 83, wherein said primary and/or secondary rocking element, when provided, has a T-shaped section and slides within said primary and/or secondary, sliding elements, respectively, by resting on at least a pair of wheels placed on the two sides of the vertical portion and below the horizontal portions of the T-shaped element, said wheels being pivoted on shafts that, at their inner end facing the T-shaped element house some balls within a suitable seat, which are, in turn, slidingly abutted against the vertical portion of the T-shaped element; at least one wheel is placed above the horizontal portion of the T-shaped element, which provides to hold the T-shaped element pressed against the lower wheels.

85. The support for a telescope according to claim 79, wherein said pivoting joining means and said articulation means are provided with frictional means to allow the telescope to be placed in the desired position and be held in this position.

86. The support for a telescope according to claim 79, wherein said pivoting joining means and said articulation means are provided with motor drive to allow both automatic pointing and tracking of the celestial body to be observed.

87. The support for telescope according to claim 86, wherein said motor drive is selected among direct or alternating current motors, stepping motors, brushless or toroidal motors.

88. The support for a telescope according to claim 68, said support comprising a command and control unit to calculate the position of the telescope and control the movements, speeds and positions, whenever required.

89. The support for a telescope according to claim 88, wherein said command and control unit comprises a memory in which there are stored the celestial coordinates of a list of observable celestial bodies, which allows for automatic pointing of the telescope to the selected object.

90. The support for telescope according to claim 74, wherein at the end proximate the secondary rocking element, the bars comprise a joint substantially having the shape of an inversed L that is arranged perpendicular to said bars such as to be joined at the ends of the secondary rocking element.

91. The support for a telescope according to claim 78, wherein the bars are either bent in the shape of an arc of circle or form a V-shaped profile, such as to be directly joined to said pivoting joining means.

92. The support for, telescope according to claim 78, wherein the connecting rod is either arc of circle-shaped or V-shaped.

93. The support for a telescope according to claim 68, comprising latitude fine adjusting means.

94. The support for a telescope according to claim 93, wherein said fine adjusting means comprise a bearing in which there is pivotally housed a pivot that is aligned with the right ascension axis and fastened to the connecting rod of the bars, on the two sides of said bearing, along an axis perpendicular to and intersecting the right ascension axis, there being arranged two threaded bars engaging respective threaded holes of a support element of the bearing, said threaded bars being actuated by respective left-right adjusting knobs; to said support element there being fastened, along an axis perpendicular to and intersecting both the right ascension axis and the axis on which said threaded bars lay, a threaded bar, the free end of which is rotatably coupled with a threaded hole that passes through a high-low adjusting knob; said high-low adjusting knob being rotatably coupled with a further threaded bar that is fixed to an end of the primary rocking element; said threaded bars having contrary threadings, i.e. a left-hand one and a right-hand one, such that, when the knob is rotated in one direction, a threaded bar will be unscrewed and the other will be screwed, and vice versa.

95. The support for a telescope according to claim 94, wherein said primary rocking element comprises an articulation at the connection with the secondary sliding element.

96. The support for a telescope according to claim 95, wherein said articulation comprises a ball arranged at the end of the primary rocking element, which is housed in a suitable spherical seat that is formed in the secondary sliding element.

97. The support for a telescope according to claim 68, wherein said rest means are selected from:
a) a low basement comprising a base element to which three or more legs are fastened such as to be radially projected therefrom;
b) a tripod, to hold the mount raised from the ground;
c) a first rest element and a second rest element that are separately connected to the mount and comprising means for connection to the mount, legs starting therefrom, at least one of said legs being extensible.

98. The support for a telescope according to claim 97, wherein said mount is removably fixed to said base element via a coupling element.

99. The support for a telescope according to claim 68, comprising bubble-level positioning means that are preferably associated with said rest means or said coupling element.

100. The support for a telescope according to claim 68, wherein said support is made of iron, steel and/or aluminum and/or carbon fiber composite materials.

101. The support for a telescope according to claim 68, said support being modular and dismountable, wherein the elements forming the mount that comprise primary and secondary rocking elements, bars, connecting rod, pivoting joining means and articulation means are assembled by means of removable joining elements.

102. The support for a telescope according to claim 68, wherein the arc of circle of the primary rocking element has an amplitude slightly greater than 90°, i.e. the minimum amplitude allowing 90° rotation to the primary rocking element.

103. The support for telescope according to claim 68, wherein the section of the primary rocking element is elongated 8-shaped, with two round lobes at the ends thereof and a substantially flat central area.

104. The support for a telescope according to claim 68, wherein the sliding element is configured such as to partially encompass the rocking element without obstructing the central area thereof, such as to avoid any interference with the pivoting joining means and secondary sliding means that are mounted in the centre of the rocking element.

105. The support for a telescope according to claim 75, wherein the arc of circle of the secondary rocking element has an amplitude slightly greater than 180°, i.e. the minimum amplitude allowing 180° rotation to the secondary rocking element.

106. The support for a telescope according to claim 68, wherein the axis AR defined by the pivoting joining means is perpendicular to the plane in which the secondary rocking element is laid and rotated.

107. The support for a telescope according to claim 68, wherein the axis AR defined by the pivoting joining means exactly passes through the center of the circle about which the secondary rocking element is developed and rotated.

108. The support for a telescope according to claim 68, wherein the axis AR defined by the pivoting joining means is perpendicular to the axis D defined by the articulation means.

109. The support for a telescope according to claim 106, wherein:
the perpendicularity between the axis AR defined by the pivoting joining means and the plane in which the secondary rocking element is laid and rotated;
the perpendicularity between the axis D defined by the articulation means and the axis AR defined by the pivoting joining means; and
the passage of the axis AR defined by the pivoting joining means through the center of the circle of the secondary rocking element;
are carried out upon manufacture with the utmost precision.

110. The support for a telescope according to claim 68, wherein the frame takes the shape of a U-shaped fork or rounded.

111. The support for a telescope according to claim 68, wherein the frame takes an asymmetric simplified shape, in order to facilitate observation.

112. The support for a telescope according to claim 74, wherein the secondary rocking element meets the frame exactly in correspondence with the axis D.

113. The support for a telescope according to claim 74, wherein the secondary rocking element meets the frame in a position offset toward the Equator relative to the axis D, when the support is properly oriented.

114. The support for a telescope according to claim 74, wherein the secondary rocking element meets the frame in a position offset toward the pole relative to the axis D, when the support is properly oriented.

115. The support for a telescope according to claim 98, wherein the base element and the coupling element are configured such as to be capable of rotating relative to each other in a controlled manner.

116. The support for a telescope according to claim 98, wherein the coupling element comprises a compass.

117. The support for a telescope according to claim 98, wherein the coupling element comprises a GPS satellite detection system.

118. The support for a telescope according to claim 98, further comprising adjustment means suitable to change the plane defined by the coupling element relative to the plane defined by the base element in a controlled manner.

119. The support for a telescope according to claim 118, wherein the adjustment means comprise three screws placed 120° away from each other along a circumference.

120. The support for a telescope according to claim 98, wherein the coupling element comprises bubble-level positioning means.

121. The support for, a telescope according to claim 68, further comprising a polar telescope.

122. The support for a telescope according to claim 68, further comprising a finder telescope.

123. The support for a telescope according to claim 121, wherein the polar telescope is integral with the mount and aligned upon manufacture with the axis AR.

124. The support for a telescope according to claim 121, wherein the polar telescope is integral with the secondary rocking element.

125. The support for a telescope according to claim 122, wherein the finder telescope is integral with the holding means and aligned upon manufacture with the geometrical axis of the housing for the telescope.

126. The support for a telescope according to claim 125, further comprising means for aligning the optical axis of the telescope with the optical axis of the finder telescope.

127. The support for a telescope according to claim 126, wherein the aligning means comprise a rotational centre that is proximate to and integral with the one of the articulation means and a fine translation apparatus proximate to the other of the articulation means.

128. The support for a telescope according to claim 127, wherein the rotational centre comprises a spherical joint.

129. The support for a telescope according to claim 127, wherein the fine translation apparatus comprises a coupling between a rack and a worm screw.

130. An optical observation system comprising a telescope and a support such as defined in claim 68, wherein said telescope is selected from a Newton, Dobson, Cassegrain, Schmidt-Cassegrain, catadioptric telescope, and variants thereof.

131. The optical observation system according to claim 130, wherein said telescope has a primary mirror diameter greater than 40 cm, preferably equal to or greater than 50 cm.

132. The optical observation system according to claim 130, wherein said telescope comprises a frame structure consisting of a support base for the primary mirror and a support ring for the secondary mirror, which are joined by rods and reinforcement rings, a further ring that is arranged intermediate between the support base and the support ring, providing to connect the telescope with the articulation means.

133. A method for properly positioning an optical observation system in accordance with claim 130, comprising the steps of:
firmly positioning the rest means such as to obtain that the plane defined by the base element is approximately horizontal;
operating the adjustment means such as to obtain that the plane defined by the coupling element is horizontal;
rotating the coupling element relative to the base element such as to obtain that the primary rocking element is parallel to the local meridian, particularly with the pivoting joining means toward the Equator and the secondary rocking element toward the astronomical pole;
rotating the primary rocking element within the primary sliding element thereof, such as to obtain that the axis defined by the pivoting joining means takes an inclination relative to the horizon which is approximately equal to the latitude of the observation place;
operating the latitude fine adjustment means such as to precisely align the axis defined by the pivoting joining means to the polar axis.

134. The positioning method according to claim 133, further comprising the steps of:
pointing the finder telescope to the astronomical pole such as to align the geometric axis of the housing of the telescope being defined by the holding means to the polar axis;
acting on the alignment means such as to align also the optical axis of the telescope to the polar axis.
